(19) United States
(12) Patent Application Publication
(10) Pub. No.: US 2007/0227821 A1
(43) Pub. Date: Oct. 4, 2007

(54) APPARATUS FOR CONTROLLING QUANTITY OF FEEDING OIL OF INVERTER COMPRESSOR

(75) Inventors: Hong-hee PARK, Seoul (KR); Myung-kyun KIEM, Kyunggi-Do (KR); Dong-won YOO, Seoul (KR); Chul-su JUNG, Seoul (KR); Byung-kil YOO, Seoul (KR); Se-heon CHOI, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONIC INC., Seoul (KR)

(21) Appl. No.: 11/760,957

(22) Filed: Jun. 11, 2007

Related U.S. Application Data
(62) Division of application No. 11/208,656, filed on Aug. 23, 2005.

(30) Foreign Application Priority Data
Mar. 30, 2005 (KR) 1020050026582
Mar. 30, 2005 (KR) 1020050026605

(51) Int. Cl. F16N 13/22

(52) U.S. Cl. 184/6

(57) ABSTRACT

An oil feed controller of an inverter compressor includes a rotation shaft having an oil passage formed in the axial direction. An oil feed pump feeds oil reserved in a shell to a compression part through the oil passage. An installation groove is formed in the rotation shaft to communicate with the oil passage. An insertion member is inserted into and fixed in the installation groove and has an oil feeding passage formed in the axial direction. An oil feed controller is installed in the oil feeding passage, and controls the quantity of oil ascending to the compression part through the oil passage by reducing the cross section of the oil passage as rotational speed of the rotation shaft is increased.

### CROSS-REFERENCE TO RELATED APPLICATION

The present Application is a divisional application based on pending U.S. patent application Ser. No. 11/208,656, filed on Aug. 23, 2005, which claims priority based upon Korean Application Nos. 10-2005-0026582, filed Mar. 30, 2005 and 10-2005-0026605, filed Mar. 30, 2005, the contents of which are expressly incorporated by reference herein in their entirety.

### BACKGROUND OF THE INVENTION

1. Field of the Invention

The present invention relates to an inverter compressor, and more particularly, to an oil feed controlling apparatus of an inverter compressor for preventing excess quantities of oil from being fed to the inverter compressor by controlling the quantity of feeding oil when rotation speed of a rotation shaft is increased.

2. Description of the Related Art

FIG. 1 is an elevation sectional view illustrating a conventional inverter compressor, and FIG. 2 is an enlarged view of the portion “A” in FIG. 1.

As shown in FIGS. 1 and 2, the conventional inverter compressor includes a shell 100 having a suction pipe 101 and a discharge pipe 102, a main frame 200 and a sub-frame 300 respectively fixed to the upper and lower sides of the shell 100, an inverter driving part 400 installed between the main frame 200 and the sub-frame 300, a rotation shaft 500 rotated by the inverter driving part 400, and a compression part 600 installed at the upper sides of the rotation shaft 500 and the main frame 200 to compress introduced gaseous refrigerant.

The inverter driving part 400 includes a rotor 401 mounted around the rotation shaft 500 and a stator 402 surrounding the rotor 401, and rotates the rotation shaft 500 at high speed or low speed to vary the quantity of compressed refrigerant when electric power is applied thereto.

The compression part 600 includes an orbiting scroll 601 installed at the upper side of the main frame 200 and coupled with the upper end of the rotation shaft 500 to orbit, a non-orbiting scroll 602 installed to the upper side of the main frame 200 to form a plurality of compression compartments in association with the orbiting scroll.

The rotation shaft 500 has an oil passage 501 formed therein in the axial direction, and an oil feeding pump 700 installed at the lower side of the rotation shaft 500 to pump and feed oil stored in the shell 100 to the compression part 600 through the oil passage 501.

The oil feeding pump 700 includes a pump cover 701 forming an oil chamber C in association with the sub-frame 300 and having an oil suction port 701a, an eccentric pumping roller 702 rotatably and eccentrically coupled with the lower end of the rotation shaft 500 to pump oil during the rotation, and a pump plate 703 disposed between the upper side of the pump cover 701 and the lower side of the eccentric pumping roller 702 to support the eccentric pumping roller 702 to slide.

In the oil feeding pump 700, the eccentric pumping roller 702 rotates in the oil chamber C due to the rotation of the rotation shaft 500 to generate a pressure difference during the rotation. Oil in the shell 100 is introduced into the oil passage 501 through the oil suction port 701a of the pump cover 701 and is compulsorily fed to the compression part 600 along the oil passage 501 of the rotation shaft 500.

However, the conventional inverter compressor has the following shortcomings.

In the conventional inverter compressor, the quantity of oil, fed through the oil passage by the compulsory flow type oil feeding pump when the conventional inverter compressor is operated at high speed, is relatively increased, and thus excess oil is fed to the compression part.

The excess oil fed to the compression part is discharged together with the compressed refrigerant out of the shell so that level of oil in the shell is lowered.

A sufficient quantity of oil is not fed to the compression part because of the lowered level of the oil in the shell due to discharge of the excess oil so that the inverter compressor cannot compress refrigerant and is deteriorated.

### SUMMARY OF THE INVENTION

Therefore, the present invention has been made in view of the above and/or other problems, and it is an object of the present invention to provide an apparatus for controlling quantity of feeding oil of an inverter compressor for adjusting quantity of oil to be fed when rotation speed of a rotation shaft is increased to prevent excess oil from being fed to a compression part.

It is another object of the present invention to provide an apparatus for controlling the quantity of feeding oil of an inverter compressor having a simple structure of adjusting quantity of oil to be fed using centrifugal force of a rotation shaft.

It is yet another object of the present invention to provide an apparatus for controlling the quantity of feeding oil of an inverter compressor having a simple structure in which a weight is elastically restored.

It is yet another object of the present invention to provide an apparatus for controlling quantity of feeding oil of an inverter compressor for significantly reducing the quantity of feeding oil using a bypass.

In accordance with the present invention, the above and other objects can be accomplished by the provision of an oil feed controller of an inverter compressor including a rotation shaft rotated by an inverter driving part and having an oil passage formed in the axial direction, an oil feed pump installed at the lower side of the rotation shaft to feed oil reserved in a shell to a compression part through the oil passage, an installation hole formed in the rotation shaft to communicate with the oil passage, a bypass formed in the rotation shaft to communicate with a leading end of the installation shaft, and an oil feed controlling part installed in the installation hole, closing the bypass when the rotation shaft is rotated at low speed, and opening the bypass when the rotation shaft is rotated at high speed so as to control the quantity of oil ascending to the compression part through the oil passage.

Preferably, the oil feed controller of an inverter compressor further includes a weight stopper formed between the leading end of the installation hole and the oil passage, a weight contacting a wall of the weight stopper and installed in the installation hole to slide outward of the installation hole due to centrifugal force of the rotation shaft, and an elastic pressing part installed in the installation hole to elastically press the weight.

The elastic pressing part includes a spring installed in the installation hole to contact a surface of the weight, and a fixing member attached to the outer circumference of the rotation shaft to fix the spring and to close a rear end of the installation hole.

The bypass is upwardly inclined from the leading end of the installation hole to the outer circumference of the rotation shaft.

The installation hole is horizontally formed to be perpendicular to the oil passage so that the weight smoothly slides due to the centrifugal force of the rotation shaft.

Moreover, the installation hole is horizontally formed to be perpendicular to the outer circumference of the rotation shaft so that the weight smoothly slides due to the centrifugal force of the rotation shaft.

Preferably, the weight stopper is formed by a leading wall of the installation hole corresponding to a surface of the weight to closely contact the surface of the weight.

A width of the weight is wider than a width of a lower opening of the bypass communicated with the installation hole such that oil is prevented from entering a space between the elastic pressing part and the weight.

Preferably, an upper inclined groove is formed in the upper side of the oil introducing passage of the weight stopper toward the lower end of the bypass.

Moreover, a lower inclined groove is formed in the lower side of the oil introducing passage of the weight stopper toward the lower end of the bypass such that oil smoothly flows from the oil passage to the bypass.

Preferably, the weight further includes an inclined surface formed in the upper side of the weight at an angle to face the lower end of the bypass such that oil smoothly flow from the oil passage to the bypass.

In accordance with the present invention, the above and other objects can be accomplished by the provision of an oil feed controller of an inverter compressor including a rotation shaft rotated by an inverter driving part and having an oil passage formed in the axial direction, an oil feed pump installed at the lower side of the rotation shaft to feed oil reserved in a shell to a compression part through the oil passage, an installation groove formed in the lower end of the rotation shaft and having an upper side to communicate with the oil passage, an insertion member inserted into and fixed in the installation groove and having an oil feeding passage formed in the axial direction and communicating with the oil passage, and an oil feed controlling part installed in the oil feeding passage, formed in the upper side of the insertion member to communicate with the oil passage, and controlling the quantity of oil ascending to the compression part through the oil passage by reducing the cross section of the oil passage as rotational speed of the rotation shaft is increased.

Preferably, the oil feed controlling part includes a sliding groove formed in the upper side of the insertion member to communicate with the oil passage, an eccentric weight inserted into the sliding groove to slide along the sliding groove, an elastic member installed between a surface of the eccentric weight and a wall of the sliding groove and elastically supporting the eccentric weight to closely contact the other wall of the sliding groove.

The eccentric weight is shifted from the center of the rotation shaft to the elastic member due to elastic force of the elastic member.

The elastic member comprises a spring having one end connected to the surface of the eccentric weight and the other end connected to the wall of the sliding groove.

Preferably, the oil feed controller of an inverter compressor further includes a bypass formed in a wall of the sliding groove, which the surface of the eccentric weight closely contacts, and penetrating the rotation shaft.

The sliding groove is horizontally formed to be perpendicular to the oil passage and the outer circumference of the rotation shaft such that the eccentric weight smoothly slides.

Moreover, the bypass is perpendicular to the outer circumference of the rotation shaft such that oil is smoothly discharged due to the centrifugal force of the rotation shaft.

The oil feed controller of an inverter compressor further includes a guide for supporting the eccentric weight to be located between the wall of the sliding groove and the surface of the eccentric weight and for guiding the eccentric weight to horizontally move.

Preferably, the guide includes a guide hole horizontally penetrating the eccentric weight, and a guide rod inserted into the guide hole to slide and horizontally installed in a wall of the sliding groove.

### BRIEF DESCRIPTION OF THE DRAWINGS

The object and advantages of the present invention will become apparent and more readily appreciated from the following description of an embodiment, taken in conjunction with the accompanying drawings, in which:

FIG. 1 is a vertical sectional view illustrating a conventional hermetic compressor;

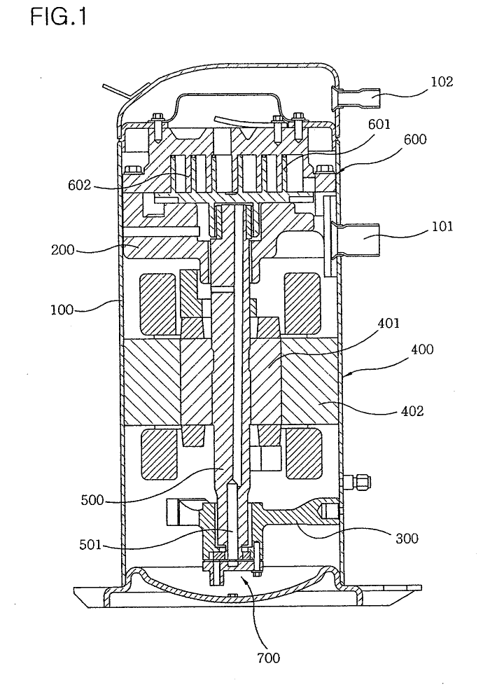

FIG. 2 is an enlarged view of the portion “A” in FIG. 1;

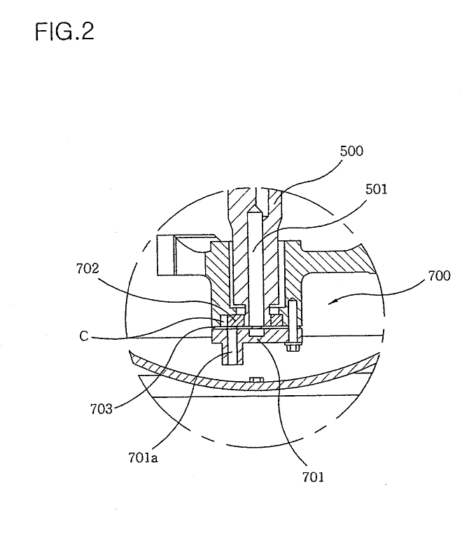

FIG. 3 is a vertical sectional view illustrating an inverter compressor employing an oil feed controller of an inverter compressor according to a first preferred embodiment of the present invention;

FIG. 4 is an enlarged view of the portion “A” in FIG. 3;

FIG. 5 is an enlarged view of the portion “A” in FIG. 3 illustrating operation of the oil feed controller of an inverter compressor according to the first preferred embodiment of the present invention when operating the inverter compressor at low speed;

FIG. 6 is an enlarged view of the portion “A” in FIG. 3 illustrating operation of the oil feed controller of an inverter compressor according to the first preferred embodiment of the present invention when operating the inverter compressor at high speed;

FIG. 7 is an enlarged view of main parts of an oil feed controller of an inverter compressor according to a second preferred embodiment of the present invention;

FIG. 8 is a vertical sectional view illustrating an inverter compressor employing an oil feed controller of an inverter compressor according to a third preferred embodiment of the present invention;

FIG. 9 is an enlarged view of the portion “B” in FIG. 8;

FIG. 10 is an enlarged view of the portion “B” in FIG. 9 illustrating operation of the oil feed controller of an inverter compressor according to the third preferred embodiment of the present invention when operating the inverter compressor at low speed;

FIG. 11 is an enlarged view of the portion “B” in FIG. 9 illustrating operation of the oil feed controller of an inverter compressor according to the third preferred embodiment of the present invention when operating the inverter compressor at high speed;

FIG. 12 is an enlarged view of main parts of an oil feed controller of an inverter compressor according to a fourth preferred embodiment of the present invention; and

FIG. 13 is an enlarged view of main parts of an oil feed controller of an inverter compressor according to a fifth preferred embodiment of the present invention.

### DESCRIPTION OF THE PREFERRED EMBODIMENTS

Hereinafter, an oil feed controller of an inverter controller according to the preferred embodiments of the present invention will be described in detail with reference to the accompanying drawings.

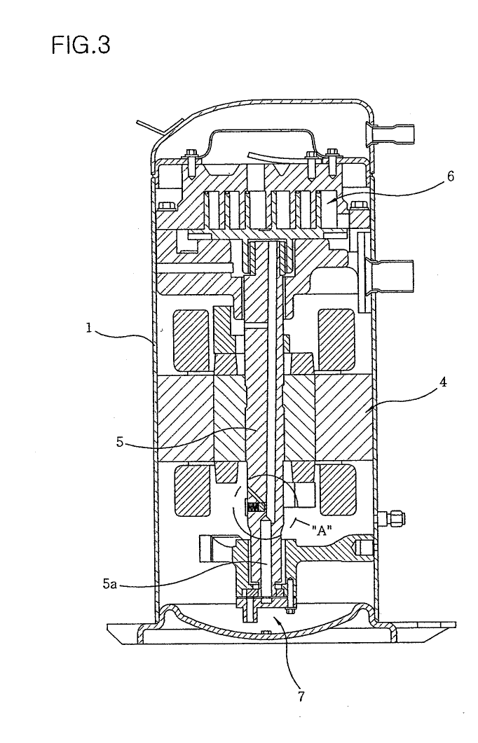

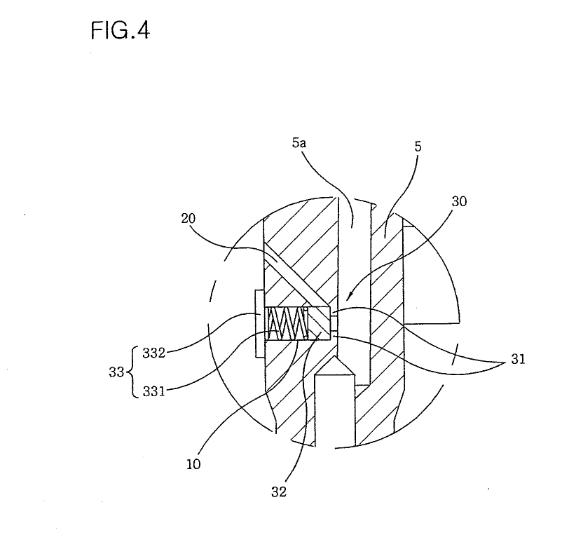

FIG. 3 is a vertical sectional view illustrating an inverter compressor employing an oil feed controller of an inverter compressor according to a first preferred embodiment of the present invention, and FIG. 4 is an enlarged view of the portion “A” in FIG. 3.

As shown in FIGS. 3 and 4, the oil feed controller of an inverter compressor according to the first preferred embodiment of the present invention includes an installation hole 10 formed in a rotation shaft 5 to communicate with an oil passage 5a of the rotation shaft 5, a bypass 20 formed in the rotation shaft 5 to communicate with a leading end of the installation hole 10, and an oil feed controlling part 30 installed in the installation hole 10. The oil feed controlling part 30 closes the bypass 20 when the rotation shaft 5 is rotated at low speed and opens the bypass 20 when the rotation shaft 5 is rotated at high speed to bypass a part of oil flowing up to a compression part 6 along the oil passage 5a to the bypass 20, thereby adjusting the quantity of oil fed to the compression part 6.

The installation hole 10 functions to guide a part of oil flowing up to the compression part 6 through the oil passage 5a by an oil feed pump 7 to the oil feed controlling part 30 and provides a space where the oil feed controlling part 30 is conveniently installed in the rotation shaft 5.

Moreover, the installation hole 10 is formed in the horizontal direction to be perpendicular to the oil passage 5a and to be perpendicular to the outer circumference of the rotation shaft 5.

This is the reason why the oil feed controlling part 30, installed in the installation hole 10, may smoothly slide along the installation hole 10 toward the outer side of the installation hole 10 due to the centrifugal force of the rotation shaft 5.

Moreover, a part of oil ascending to the compression part 6 enters the bypass 20 via the installation hole 10 and bypasses the outside of the rotation shaft 5 through the outer circumference of the rotation shaft 5.

Preferably, the bypass 20 extends upwardly from the leading end of the installation hole 10 to the outer circumference of the rotation shaft 5 at an angle. This is the reason why the part of oil, ascending to the compression part 6 through the oil passage 5a may enter the bypass 20 due to the ascending force of oil caused by the rotation of the rotation shaft 5 and may smoothly flow through the bypass 20 to the outside of the rotation shaft 5.

Moreover, the oil feed controlling part 30 includes a weight stopper, disposed between the leading end of the installation hole 10 and having an oil introducing passage 31 for connecting the oil passage 5a to the installation hole 10, a weight 32 disposed in the installation hole 10, contacting a surface of the oil introducing passage 31, and sliding along the installation hole 10 due to the centrifugal force of the rotation shaft 5, and an elastic pressing part 33 installed in the installation hole 10 to elastically press the weight 32 against the weight stopper 31.

The elastic pressing part 33 includes a spring 331 installed in the installation hole 10 to contact the surface of the weight 32 and a fixing member 332 attached to the outer circumference of the rotation shaft 5 to close the outer side of the installation hole 10 and fix an end of the spring 331.

The oil feed controlling part 30 closes the bypass 20 and the oil introducing passage 31a when the inverter driving part is driven at a low frequency, i.e., when the rotation shaft 5 is slowly rotated by the inverter driving part 4.

In other words, when the weight 32 is stopped in the installation hole 10 due to friction between the weight 32 and the installation hole 10 and the elastic force of the spring 331 because of weak centrifugal force of the rotation shaft 5, a surface of the weight 32 located at the leading end of the installation hole 10 communicated with the oil passage 5a closely contact the surface of the weight stopper 31 such that the weight 32 closes the oil introducing passage 31a and the bypass 20.

The oil feed controlling part 30 opens the bypass 20 and the oil introducing passage 31a when the inverter driving part is driven at a high frequency, i.e., the rotation shaft 5 is rapidly rotated by the inverter driving part 4 such that a part of oil ascending to the compression part 6 via the oil passage 5a is bypassed to the outside of the rotation shaft 5.

In other words, when the centrifugal force of the rotation shaft 5 is greater than the sum of the friction between the weight 32 and the installation hole 10 and elastic force of the spring 331, the weight 32 slides along the installation hole 10 due to the centrifugal force of the rotation shaft 5 to the outer side of the installation hole 10 to press the spring 331 such that a surface of the weight 32 is separated from the weight stopper 31 and the bypass 20 and the oil passage 31a are opened. Thus, a part of oil ascending to the compression part 6 via the oil passage 5a enters the oil introducing passage 31a and the bypass 20 via the installation hole 10. The oil in the bypass 20 is bypassed to the outside of the rotation shaft 5 via an opening formed in the outer circumference of the rotation shaft 5.

As such, according to the oil feed controller of an inverter compressor of the first preferred embodiment of the present invention, since, when the inverter driving part 4 is driven at high speed, a part of oil, fed to the compression part 6 along the oil passage 5a by the oil feed pump 7, is bypassed to the outside of the rotation shaft 5, oversupply of oil to the compression part 6 is prevented, and increase of discharge of oil is also prevented. Thus, the level of oil is prevented from lowering due to the excess discharge.

Preferably, the weight stopper 31 is an inner wall of the installation hole 10 corresponding to the surface of the weight 32. This is reason why the oil introducing passage 31a, formed in the weight stopper 31 to communicate with the oil passage 5a, may be closed by the surface of the weight 32 when the surface of the weight 32 closely contacts the weight stopper 31.

The elastic pressing part 33 closes the oil introducing passage 31a formed in the rotation shaft 5 to seal the installation hole 10 by the fixing member 332 for fixing an end of the spring 331 for elastically supporting the weight 32.

Preferably, the width of the weight 32 is greater than the width of a lower opening of the bypass communicating with the installation hole 10, so that oil, remaining in the bypass 20 because the lower opening of the bypass 20 is closed by the weight 32 closely contacting the weight stopper 31, is prevented from entering the installation hole 10.

In other words, the weight 32 intercepts the communication between the installation hole 10 and the bypass 20 to preventing oil remaining in the bypass 20 from entering a space between the fixing member 332 and the weight 32, so that elastic force applied to the weight 32 due to oil entering the space between the fixing member 332 and the weight 32 is prevented from being increased.

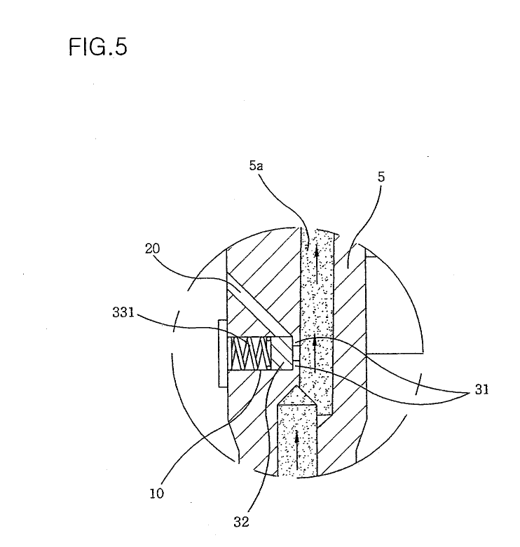

FIG. 5 is an enlarged view of main parts of the oil feed controller illustrating operation of the oil feed controller of an inverter compressor according to the first preferred embodiment of the present invention when operating the inverter compression part 4 at low speed.

As shown in FIG. 5, when the rotation shaft 5 is rotated at low speed, the weight 32 is stopped due to friction between the weight 32 and the installation hole 10 and elastic force of the spring 331 because weak centrifugal force of the rotation shaft 5.

At that time, the weight 32 is stopped and closely contacts the weight stopper 31 in the installation hole 10, and the oil passage 5a and the bypass 20 communicating with the installation hole 10 are sealed. Thus, oil is smoothly ascended to the compression part 6 through the oil passage 5a when the inverter driving part 4 is driven at low speed.

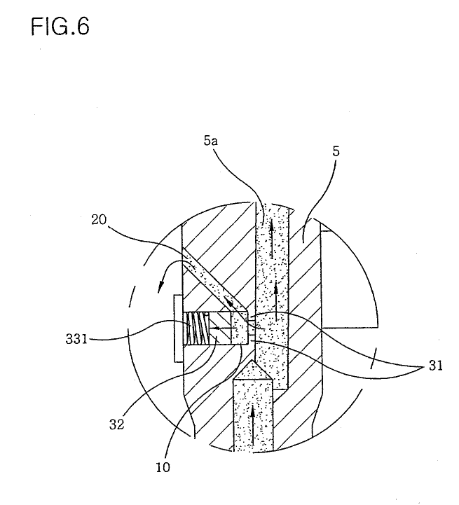

FIG. 6 is an enlarged view of main parts of the oil feed controller illustrating operation of the oil feed controller of an inverter compressor according to the first preferred embodiment of the present invention when operating the inverter compressing part 4 at high speed.

As shown in FIG. 6, when the rotation shaft 5 is rotated at high speed, since the centrifugal force of the rotation shaft 5 is greater than the sum of friction between the weight 32 and the installation hole 10 and elastic force of the spring 331, the weight 32 overcomes the friction between the weight 32 and the installation hole 10 and the elastic force of the spring 331 and slides along the installation hole 10 toward the outer side of the rotation shaft 5 to compress the spring 331.

As such, when the weight 32 slides along the installation hole 10 and is separated from the weight stopper 31 formed in the entrance of the installation hole 10, the oil passage 31a and the lower opening of the bypass 20 are opened. At that time, a part of oil ascending to the compression part 6 along the oil passage 5a enters the installation hole 10 via the oil introducing passage 31a and bypasses to the outer circumference of the rotation shaft 5 via the bypass 20.

Thus, when the rotation shaft 5 is rotated at high speed, a part of oil ascending to the compression part 6 is bypassed to a space between the shell 1 and the rotation shaft 5 via the bypass 20 so that excess feed of oil to the compression part 6 is prevented. As a result, the quantity of oil fed to the compression part 6 is uniformly controlled.

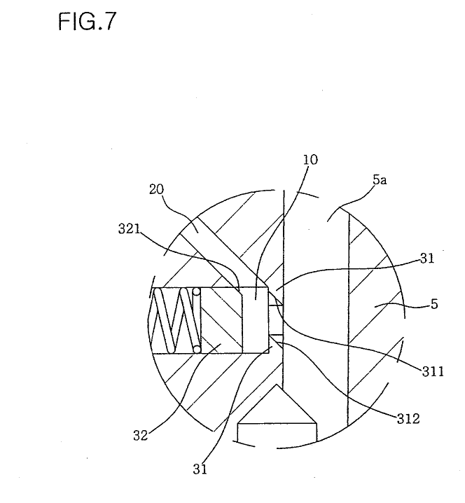

FIG. 7 is an enlarged view of main parts of an oil feed controller of an inverter compressor according to a second preferred embodiment of the present invention.

As shown in FIG. 7, the oil feed controller of an inverter compressor according to the second preferred embodiment of the present invention includes all elements of the oil feed controller according to the first preferred embodiment of the present invention except for a weight stopper 31. Thus, in this preferred embodiment, description of all elements except for the weight stopper 31 is omitted. The oil feed controller of an inverter compressor according to the second preferred embodiment of the present invention includes an upper inclined groove 311 formed in the inner upper side of the oil introducing passage 31a of the weight stopper 31 at an angle, a lower inclined groove 312 formed in the inner lower side of the oil introducing passage 31a facing the lower opening of the bypass 20 at an angle, and an inclined surface 321 formed in the upper side of the weight 32 at an angle to face the lower opening of the bypass 20.

When the rotation shaft 5 is rotated at high speed and the weight 32 slides along the installation hole 10 to open the bypass 20, the upper inclined groove 312, the lower inclined groove 312, and the inclined surface 321 allow oil to smoothly flow from the oil passage 5a of the rotation shaft 5 to the bypass 20.

In other words, oil, flowing from the oil passage 5a to the bypass 20, is guided to flow through the bypass 20 due to the upper inclined groove 311, the lower inclined groove 312, and the inclined surface 321 so that oil easily flows toward the bypass 20.

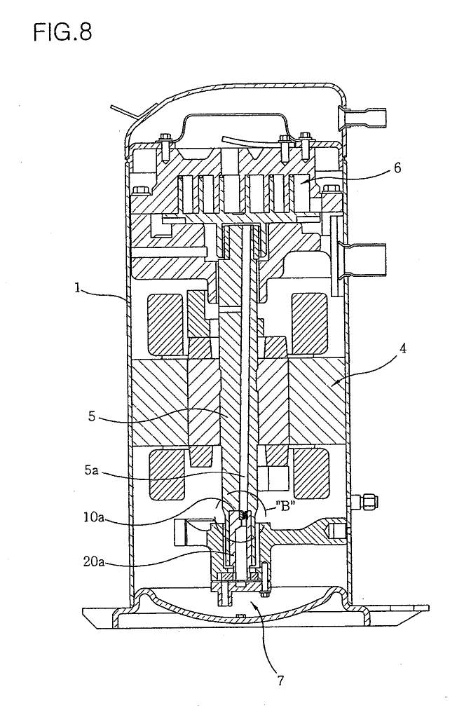

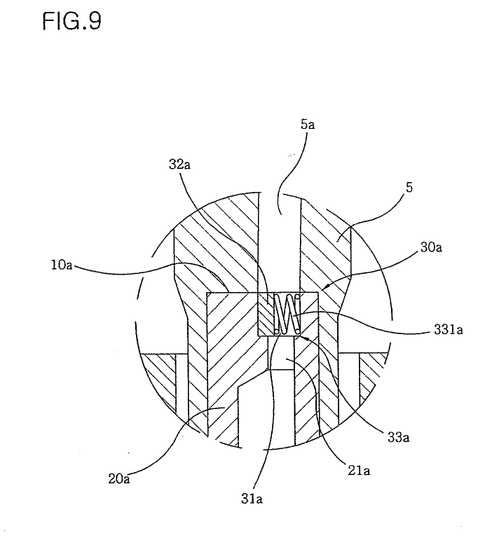

FIG. 8 is a vertical sectional view illustrating an inverter compressor employing an oil feed controller of an inverter compressor according to a third preferred embodiment of the present invention, and FIG. 9 is an enlarged view of the portion “B” in FIG. 8.

As shown in FIGS. 8 and 9, the oil feed controller of an inverter compressor includes an installation groove 10a formed in the lower end of the rotation shaft 5 and having an upper side to communicate with the oil passage 5a, an insertion member 20a inserted into the installation groove 10a and having an oil feeding passage 21a formed in the longitudinal direction and communicating with the oil passage 5a, an oil feed controlling part 30a, installed in the oil feeding passage 21a which is formed in the upper side of the insertion member 20a and communicates with the oil passage 5a, and reducing cross-section of the oil feeding passage 21a as rotational speed of the rotation shaft 5 is increased so as to adjust the quantity of oil ascending to the compression part via the oil passage 5a.

The installation groove 10a is formed in the lower side of the rotation shaft 5 and serves as a space into which the insertion member 20a is inserted and fixed.

Moreover, the insertion member 20a is inserted into the installation groove 10a and has the oil feeding passage 21a formed therein in the vertical direction. The insertion member 20a provides a space where the oil feed controlling part 30 is installed. Due to the insertion member 20a, the oil feed controlling part 30a, manufactured and assembled in the exterior of the inverter compressor, is conveniently installed in the rotation shaft 5 via the installation groove 10a.

The oil feeding passage 21a is formed in the insertion member 20a to communicate with the oil passage 5a of the rotation shaft 5. Oil in the shell 1 enters the lower side of the oil feeding passage 21a due to the oil feed pump 7 and passes through the oil feeding passage 21a to ascend to the compression part through the oil passage 5a.

The oil feed controlling part 30a includes a sliding groove 31a formed in the upper side of the insertion member 20a and communicating with the oil feeding passage 21a, an eccentric weight 32a shifted from the center of the rotation shaft 5 to slide along the sliding groove 31a, and an elastic member 33a installed between a surface of the eccentric weight 32a and a wall of the sliding groove 31a and elastically supporting the eccentric weight 32a to closely contact the other wall of the sliding groove 31a.

The eccentric weight 32a is shifted from the center of the rotation shaft 5 to the elastic member 33a due to the elastic force of the elastic member 33a so that the eccentric weight 32a is smoothly slid toward the elastic member 33a by the centrifugal force of the rotation shaft 5 during rotation of the rotation shaft 5.

The elastic member 33a includes a spring 331a having one end connected to a surface of the eccentric weight 32a and the other end connected to the wall of the sliding groove 31a.

Since centrifugal force of the rotation shaft 5 is weak when the inverter driving part 4 is operated at low frequency, i.e. when the rotation shaft 5 is rotated at low speed by the inverter driving part 4, the oil feeding controlling part 30a is stopped by friction between the eccentric weight 32a and the sliding groove 31a and elastic force of the elastic member 33a, i.e. the spring 331a. Thus, since the eccentric weight 32a maintains close contact with the other wall of the sliding groove 31a, the oil feeding passage 21a communicating with the oil passage 5a is continuously opened.

As such, since the oil feeding passage 21a is kept open, oil ascended to the compression part by the oil feed pump 7 smoothly enters the oil passage 5a via the oil feeding passage 21a.

Since centrifugal force of the rotation shaft 5 is greater than the sum of friction between the eccentric weight 32a and the sliding groove 31a and elastic force of the spring 331 as an elastic member 33a when the inverter driving part 4 is operated at high frequency, i.e. when the rotation shaft 5 is rotated at high speed by the inverter driving part 30a, the oil feed controlling part 30a slides along the sliding groove 31a toward the wall so that the eccentric weight 32a compresses the spring 331a to close a part of the oil feeding passage 21a.

As described above, when the eccentric weight 32a partially closes the oil feeding passage 21a, the oil passage 21a is reduced and the quantity of oil ascending to the compression part through the oil feeding passage 21a is reduced.

In addition, since centrifugal force of the rotation shaft 5 is gradually increased as operating frequency of the inverter driving part 4 is increased, the distance that the eccentric weight 32a moves along the sliding groove 31a is also gradually increased.

In other words, the eccentric weight 32a slides further as the rotational speed of the rotation shaft 5 is increased so that the opened cross section of the oil feeding passage 21a is gradually reduced and quantity of oil entering the oil passage 5a via the oil feeding passage 21a is controlled.

Since the eccentric weight 32a is shifted from the center of the rotation shaft 5, the eccentric weight 32a slides due to the centrifugal force of the rotation shaft 5.

As such, the quantity of oil ascending to the compression part due to the oil feed pump 7 is properly reduced at the oil feeding passage 21a by the eccentric weight 32a when the rotation shaft 5 is rotated at high speed, so that excess oil, fed from the oil feeding passage 21a to the compression part 6 via the oil passage 5a, is prevented and lowering level of oil in the shell 1 is also prevented.

The elastic member 33a applies elastic force to the eccentric weight 32a, and includes the spring 331a and other various elastic supporting members.

The sliding groove 31a is formed in the horizontal direction perpendicular to the oil feeding passage 21a and is formed in the direction perpendicular to the outer circumference of the rotation shaft 5, so that the eccentric weight 32a smoothly slides along the sliding groove 31a due to the centrifugal force of the rotation shaft 5.

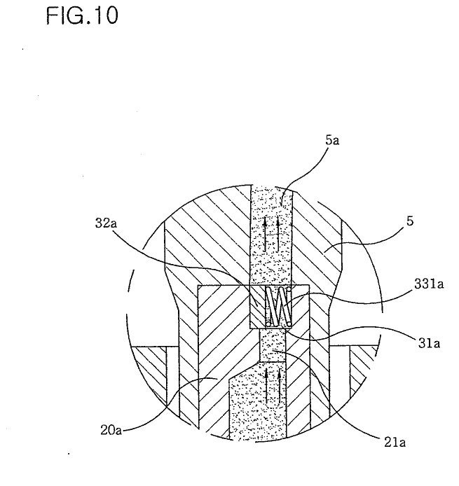

FIG. 10 is an enlarged view of main parts illustrating operation of the oil feed controller of an inverter compressor according to the third preferred embodiment of the present invention when operating the inverter compressor at low speed.

As shown in FIG. 10, since centrifugal force of the rotation shaft 5 is weak when the rotation shaft 5 is rotated at low speed, the eccentric weight 32a is stopped by friction between the eccentric weight 32a and the sliding groove 31a and elastic force of the spring 331a.

As such, when the eccentric weight 32a contacts the other wall of the sliding groove 31a and stops, the oil feeding passage 21a formed in the insertion member 20a is opened, and oil ascending to the compression part 6 through the oil feeding passage 21a smoothly enters the oil passage 5a of the rotation shaft 5 when the rotation shaft 5 is rotated at low speed.

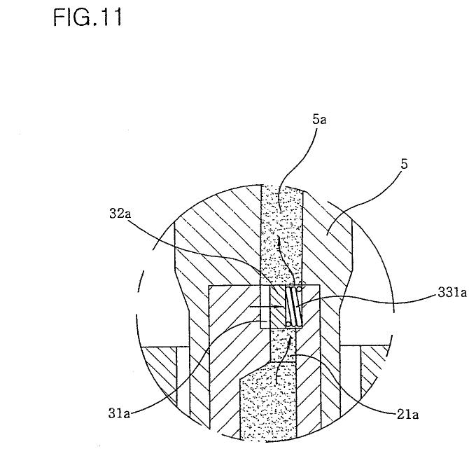

FIG. 11 is an enlarged view of main parts illustrating operation of the oil feed controller of an inverter compressor according to the third preferred embodiment of the present invention when operating the inverter compressor at high speed.

As shown in FIG. 11, since centrifugal force of the rotation shaft 5 is greater than the sum of friction between the eccentric weight 32a and the sliding groove 31a and elastic force of the spring 331a when the rotation shaft 5 is rotated at high speed, the eccentric weight 32a slides along the sliding groove 31a toward the wall of the sliding groove 31a to compress the spring 331a.

As described above, when the eccentric weight 32a slides along the sliding groove 31, the oil feeding passage 21a communicating with the lower end of the sliding groove 31a is partially closed so that opened cross section of the oil feeding passage 21a is reduced and the quantity of oil ascending to the oil passage 5a of the rotation shaft 5 via the oil feeding passage 21a is also reduced.

At that time, the distance that the eccentric weight 32a slides is in proportion to rotational speed of the rotation shaft 5 and cross section of the oil feeding passage 21a is reduced in proportion to the sliding distance of the eccentric weight 32a, so that the quantity of oil ascending to the compression part 6 through the oil passage 5a is gradually reduced as the rotational speed of the rotation shaft 5 is increased.

Thus, since the cross section of the oil feeding passage 21a is gradually reduced when the rotation shaft 5 is rotated at high speed, the quantity of oil ascending to the compression part 6 through the oil passage 5a is reduced so that oversupply of oil to the compression part 6 is prevented and the quantity of oil fed to the compression part 6 is adjusted when the rotation shaft 5 is rotated at high speed.

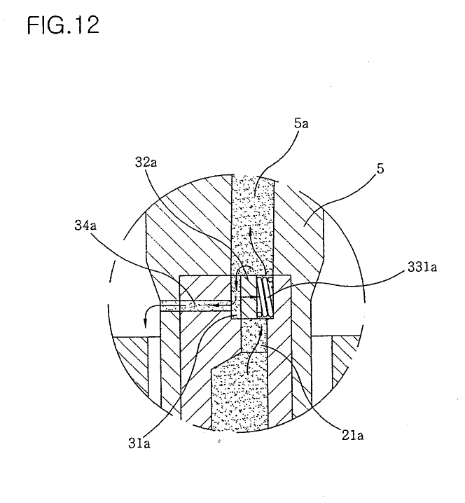

FIG. 12 is an enlarged view of main parts of an oil feed controller of an inverter compressor according to a fourth preferred embodiment of the present invention.

As shown in FIG. 12, since centrifugal force of the rotation shaft 5 is greater than the sum of friction between the eccentric weight 32a and the sliding groove 31a and elastic force of the spring 331a when the rotation shaft 5 is rotated at high speed, the eccentric weight 32a slides toward the wall of the sliding groove 31a along the sliding groove 31a to compress the spring 331a.

As such, when the eccentric weight 32 slides along the sliding groove 31a, the oil feeding passage 21a communicated with the lower end of the sliding groove 31a is partially closed so that the opened cross section of the oil feeding passage 21a is reduced and the quantity of oil ascending to the oil passage 5a of the rotation shaft 5 via the oil feeding passage 21a is also reduced.

At that time, when the eccentric weight 32a slides, oil in the oil passage 5a bypasses through the bypass 34a formed in the other wall of the sliding groove 31a and penetrates the rotation shaft 5.

As described above, when the rotation shaft 5 is rotated at high speed, oil in the oil passage 5a bypasses to the outside of the rotation shaft 5 through the bypass 34a so that the quantity of oil fed to the compression part 6 through the oil passage 5a is remarkably reduced.

Preferably, the bypass 34a is formed perpendicular to the outer circumference of the rotation shaft 5 so that oil is smoothly bypassed due to centrifugal force of the rotation shaft 5.

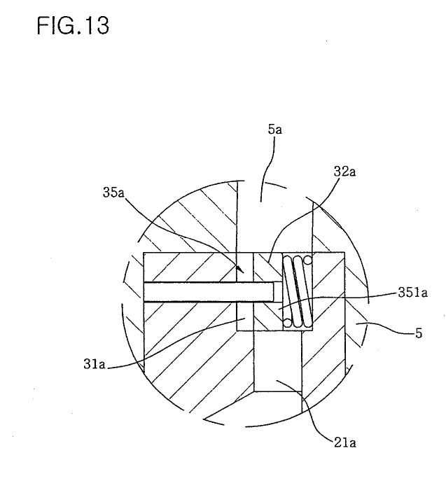

FIG. 13 is an enlarged view of main parts of an oil feed controller of an inverter compressor according to a fifth preferred embodiment of the present invention.

As shown in FIG. 13, the oil feed controller of an inverter compressor further includes a guide 35a for supporting the eccentric weight 32a to be located between the wall of the sliding groove 31a and a surface of the eccentric weight 32a and for guiding the eccentric weight 32a to move horizontally.

The guide 35a includes a guide hole 351a horizontally penetrating the eccentric weight 32a and a guide rod 352a inserted into the guide hole 351a to slide and horizontally installed at a wall of the sliding groove 31a.

When the eccentric weight 32a horizontally moves due to centrifugal force of the rotation shaft 5, the guide 35a supports the eccentric weight 32a using the guide rod 352a inserted into the guide hole 351a and guides the eccentric weight 32a to horizontally move.

In other words, since the guide rod 352a is inserted into the guide hole 351a formed in the eccentric weight 32a to slide, the guide 35a supports the eccentric weight 32a to prevent the eccentric weight 32a from vibrating up and down due to oil ascending from the oil feeding passage 21a to the oil passage 5a of the rotation shaft 5 so that the eccentric weight 32a is guided by the guide rod 352a and horizontal movement of the eccentric weight 32a is accurately performed.

As described above, the oil feed controller of an inverter compressor according to the present invention prevents excess oil from being fed to the compression part by reducing the quantity of feeding oil when the rotational speed of the rotation shaft is increased so that oil discharge is reduced and the level of oil reserved in the shell is prevented from lowering. Thus, reliability of the inverter compressor is enhanced.

Moreover, since the oil feed controller of an inverter compressor according to the present invention has a simple structure for controlling the quantity of feeding oil using centrifugal force of the rotation shaft, the oil feed controller is convenient to manufacture and install and stability and accuracy of the inverter compressor are enhanced.

Since the oil feed controller of an inverter compressor according to the present invention has a simple structure for elastically restoring the weight, the oil feed controller is convenient to assemble and install and stability and accuracy of the inverter compressor are enhanced.

Further, since the quantity of feeding oil is remarkably reduced due to the bypass, oil discharge is also remarkably reduced to prevent level of oil from lowering.

Although the preferred embodiment of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An oil feed controller of an inverter compressor, comprising:
a rotation shaft having an oil passage formed in an axial direction;
an oil feed pump to feed oil reserved in a shell to a compression part through the oil passage;
an installation groove formed in the rotation shaft to communicate with the oil passage;
an insertion member inserted into and fixed in the installation groove and having an oil feeding passage formed in the axial direction; and
an oil feed controller installed in the oil feeding passage, and controlling the quantity of oil ascending to the compression part through the oil passage by reducing the cross section of the oil passage as rotational speed of the rotation shaft is increased.

2. The oil feed controller according to claim 1,
wherein the oil feed controller comprises:
a sliding groove formed in an upper side of the insertion member to communicate with the oil passage;
an eccentric weight inserted into the sliding groove to slide along the sliding groove;
an elastic member installed between a surface of the eccentric weight and a first wall of the sliding groove and elastically supporting the eccentric weight to closely contact a second wall of the sliding groove opposite the first wall.

3. The oil feed controller according to claim 2,
wherein the eccentric weight is shifted from a center of the rotation shaft due to elastic force of the elastic member.

4. The oil feed controller according to claim 2,
wherein the elastic member comprises a spring having a first end connected to the surface of the eccentric weight and a second end connected to the wall of the sliding groove.

5. The oil feed controller according to claim 2, further comprising:
a bypass formed in a wall of the sliding groove and penetrating the rotation shaft,
wherein the surface of the eccentric weight is configured to contact the bypass.

6. The oil feed controller according to claim 2,
wherein the sliding groove is horizontally formed to be perpendicular to the oil passage.

7. The oil feed controller according to claim 1,
wherein the oil feed pump is installed at a lower side of the rotation shaft.

8. The oil feed controller according to claim 1,
wherein the installation groove is formed in a lower end of the rotation shaft and has an upper side to communicate with the oil passage.

9. The oil feed controller according to claim 1,
wherein the oil feeding passage communicates with the oil passage.

10. The oil feed controller according to claim 1,
wherein the oil feed controller is formed in an upper side of the insertion member to communicate with the oil passage.

11. The oil feed controller according to claim 1, further comprising:
an inverter driving part configured to rotate the rotation shaft.
